(19) United States
(12) Patent Application Publication
(10) Pub. No.: US 2015/0087301 A1
(43) Pub. Date: Mar. 26, 2015

(54) GEO-LOCATION ASSISTED CELLULAR NETWORK DISCOVERY

(71) Applicant: Broadcom Corporation, Irvine, CA (US)

(72) Inventor: Amit CHOUDHARY, Bangalore (IN)

(73) Assignee: Broadcom Corporation, Irvine, CA (US)

(21) Appl. No.: 14/037,283

(22) Filed: Sep. 25, 2013

Related U.S. Application Data
(60) Provisional application No. 61/880,781, filed on Sep. 20, 2013.

(51) Int. Cl. H04W 48/16

(52) U.S. Cl. CPC H04W 48/16
USPC 455/434

(57) ABSTRACT

A mobile device includes a global navigation satellite system (GNSS) module, a modem, a memory, and an application processor. The GNSS module is configured to determine geographical location information of the mobile device. The memory is configured to store the geographical location information and associated cell information including previously camped cell information entries associated with respective geographical location information. The modem is coupled to the GNSS module and configured to perform a cell search based on previously camped cell information associated with the geographical location information. The modem may retrieve one of the previously camped cell information entries from the memory based on corresponding geographical location information. The application processor is coupled to the GNSS module and modem, and configured to store association data in the memory. The association data includes the geographical location information from the GNSS module and associated cell information from the modem.

### CROSS-REFERENCE TO RELATED APPLICATIONS

The present application claims the benefit of U.S. Provisional Patent Application Ser. No. 61/880,781, titled “GEO-LOCATION ASSISTED CELLULAR NETWORK DISCOVERY,” filed on Sep. 20, 2013, which is hereby incorporated by reference in its entirety for all purposes.

### TECHNICAL FIELD

The present description relates to wireless communication systems, and more particularly, but not exclusively, to satellite communications and cellular network discovery.

### BACKGROUND

Cellular network discovery (e.g., Long Term Evolution (LTE) network search) can be a time consuming process if the LTE user equipment (UE) is required to do a blind search. The blind search involves searching all carrier frequencies in supported bands for LTE cells, and in turn, evaluating the found LTE cells for public land mobile network (PLMN) suitability criteria. Reducing the blind LTE cell search time is essential for user experience, e.g. if a user travels and powers on LTE phone in a new geographical location, a long delay may be experienced if the blind search for an LTE cell is not optimized. In addition, the LTE cell search time can be used as a performance benchmarking metric for LTE devices available in the market.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 is a diagram illustrating an exemplary communication system that is operable to support satellite communications over mobile devices that are integrated with global navigation satellite system (GNSS) modules, in accordance with various aspects of the subject technology.

FIG. 2 is a block diagram illustrating an exemplary cellular communication network included in the communication system of FIG. 1, in accordance with various aspects of the subject technology.

FIG. 3 is a block diagram illustrating an example of a GNSS enabled receiver in accordance with various aspects of the subject technology.

FIG. 4 is a diagram illustrating an example of a communication exchange of geo-location information and associated cell information, in accordance with various aspects of the subject technology.

FIG. 5 is a diagram illustrating an example of a communication exchange for geo-location assisted cellular network discovery, in accordance with various aspects of the subject technology.

FIG. 6 conceptually illustrates an electronic system with which aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology.

In some aspects, the subject disclosure provides utilization of geo-location information available from an in-device global navigation satellite system (GNSS) module to improve cellular network (e.g., LTE) acquisition times since mobile devices are increasingly becoming GNSS enabled. The cellular network discovery based on the mobile device's geo-location information avoids the need to perform blind searches for subsequent searches. In this regard, the availability of the geo-location information enables the mobile device to perform network acquisitions in less time.

In some implementations, a mobile device includes a GNSS module, a modem, a memory, and an application processor. The GNSS module is configured to determine geographical location information of the mobile device. The memory is configured to store the geographical location information and associated cell information including previously camped cell information entries associated with respective geographical location information. The modem is coupled to the GNSS module and configured to perform a cell search based on previously camped cell information associated with the geographical location information. The modem may retrieve one of the previously camped cell information entries from the memory based on corresponding geographical location information. The application processor is coupled to the GNSS module and modem, and configured to store association data in the memory. The association data includes the geographical location information from the GNSS module and associated cell information from the modem.

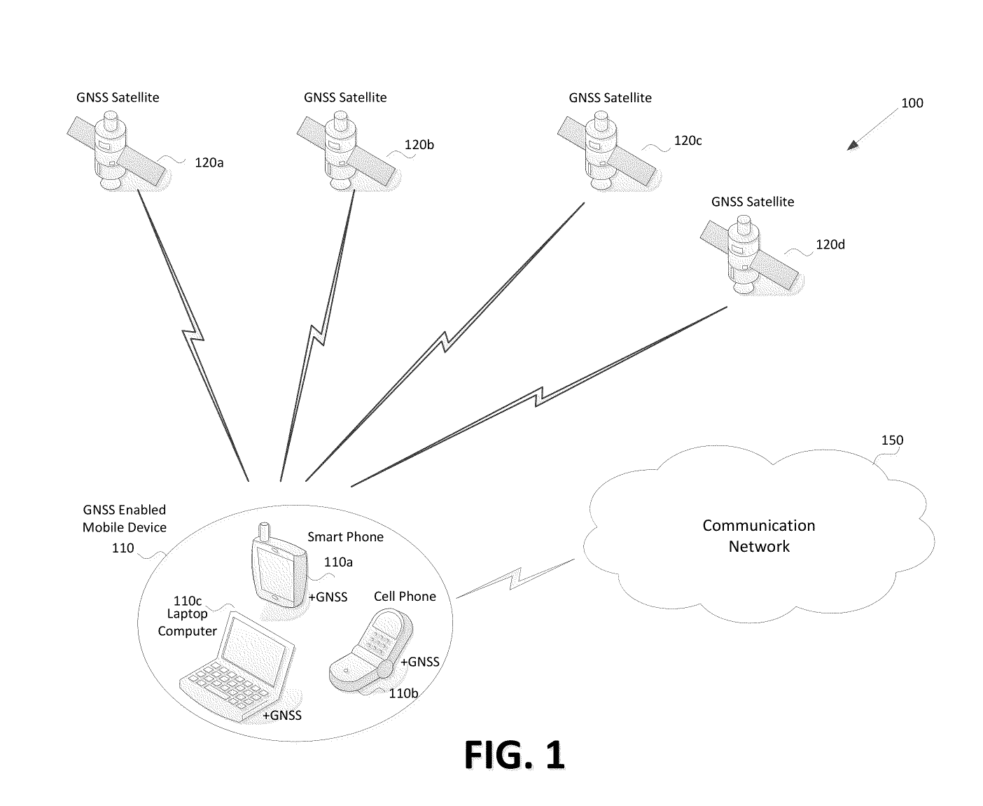

FIG. 1 is a diagram illustrating an exemplary communication system 100 that is operable to support satellite communications over mobile devices that are integrated with global navigation satellite system (GNSS) modules, in accordance with one or more implementations of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The communication system 100 includes multiple GNSS-enabled mobile devices 110, of which GNSS-enabled mobile devices 110a-110c are illustrated, a GNSS infrastructure 120, and a communication network 130. The GNSS infrastructure 120 includes multiple GNSS satellites, of which GNSS satellites 120a-120d are presented. The Global Positioning System (GPS), the Global Orbiting Navigation Satellite System (GLONASS), and the satellite navigation system GALILEO are three examples of Global Navigation Satellite Systems (GNSSs). Various GNSS measurements such as pseudorange, carrier phase, and/or Doppler may be used by GNSS receivers (e.g., GNSS enabled mobile devices 110a-110c) to calculate navigation information such as GNSS receiver positions, velocity, and time.

A GNSS-enabled mobile device, such as GNSS-enabled mobile device 110a, may be operable to concurrently communicate radio frequency signals using multiple radio communication technologies. The radio communication technologies may be integrated within a GNSS integrated circuit chip integrated inside the GNSS-enabled mobile device 110a. Using the GNSS integrated circuit chip, the GNSS-enabled mobile device 110a may be operable to concurrently communicate radio frequency signals across, for example, the communication network 130. The GNSS-enabled mobile device 110a may be operable to take full GNSS measurements from GNSS radio frequency signals received from visible GNSS satellites such as the GNSS satellites 120a-120d. The full GNSS measurement may include pseudo-range, carrier phase, and/or Doppler, which may be calculated using the received GNSS signals from visible GNSS satellites of a full GNSS satellite constellation (e.g., GPS, GALILEO, GLONASS). The full GNSS measurements may be calculated inside the GNSS integrated circuit chip.

The GNSS enabled mobile device 110a may include correlators within the GNSS integrated circuit chip to search and/or detect GNSS radio frequency signals from the visible GNSS satellites such as the GNSS satellites 120a-120d. Specific time and/or location related information embedded in radio frequency signals received from, for example, the communication network 130 may be extracted. The extracted specific time and/or location related information may be used as GNSS reference information or GNSS assistance data. The GNSS-enabled mobile device 110a may be operable to provide or input the extracted GNSS reference information into the integrated GNSS integrated circuit chip to assist the full GNSS measurement.

The full GNSS measurement may be processed via a navigation process to calculate a full navigation solution. The full navigation solution may include GNSS time tagged navigation information such as, for example, a position, orientation, attitude, velocity, and/or clock information of the GNSS-enabled mobile device 110a. The navigation process may be performed internal to and/or external to the integrated GNSS integrated circuit chip depending on where a corresponding navigation engine would be. The full GNSS navigation solution may be applied to various navigation services such as, for example, traffic alerts on the GNSS-enabled mobile device 110a. The GNSS-enabled mobile device 110a may be operable to concurrently transmit and receive FM radio frequency signals over an integrated FM radio to support multiple location-based services such as, for example, traffic alerts and turn-by-turn navigation, at the same time.

A GNSS satellite such as the GNSS satellite 120a may be operable to provide satellite navigational information to various GNSS receivers on earth. The GNSS receivers, which include GPS, GALILEO and/or GLONASS receivers, may be integrated internally to or externally coupled to GNSS-enabled mobile devices such as the GNSS-enabled mobile devices 110a-110c. The GNSS satellite 120a may be operable to broadcast its own ephemeris periodically, for example, once every specified period of time (e.g., 30 seconds). The broadcast ephemeris may be utilized by the GNSS integrated circuit chip to calculate navigation information such as, for example, a position, velocity, and/or clock information of the GNSS receivers. In this regard, the GNSS integrated circuit chip is utilized to calculate navigation information such as, for example, a position, velocity, and/or clock information of the GNSS receivers without intervention from a host processor in corresponding GNSS-enabled mobile devices.

The communication network 130 may include multiple base stations. The communication network 130 may be operable to provide data services to various mobile devices such as the GNSS-enabled mobile devices 110a-110c by using cellular communication technologies and/or Worldwide Interoperability for Microwave Access (WiMAX) technology. The cellular communication technologies may include, for example, Global System for Mobile communications (GSM), General Packet Radio Services (GPRS), Universal Mobile Telecommunications System (UMTS), Enhanced Data rates for GSM Evolution (EDGE), Enhanced GPRS (EGPRS), and/or 3GPP Long Term Evolution (LTE).

The communication network 130 may be operable to communicate radio frequency signals including specific physical location information such as an International Mobile Subscriber Identity (IMSI), a Mobile Network Code (MNC), a Mobile Country Code (MCC), a Location Area Code (LAC), Cell ID, a Radio Network Controller (PNC) ID, and/or a base station ID. The specific physical location information embedded in the received radio frequency signals may provide information, for example, service providers and/or service serving areas. The embedded specific physical location information may be utilized by, for example, the GNSS-enabled mobile device 110a as GNSS reference information or GNSS assistance data to assist full GNSS measurement within a corresponding GNSS integrated circuit chip.

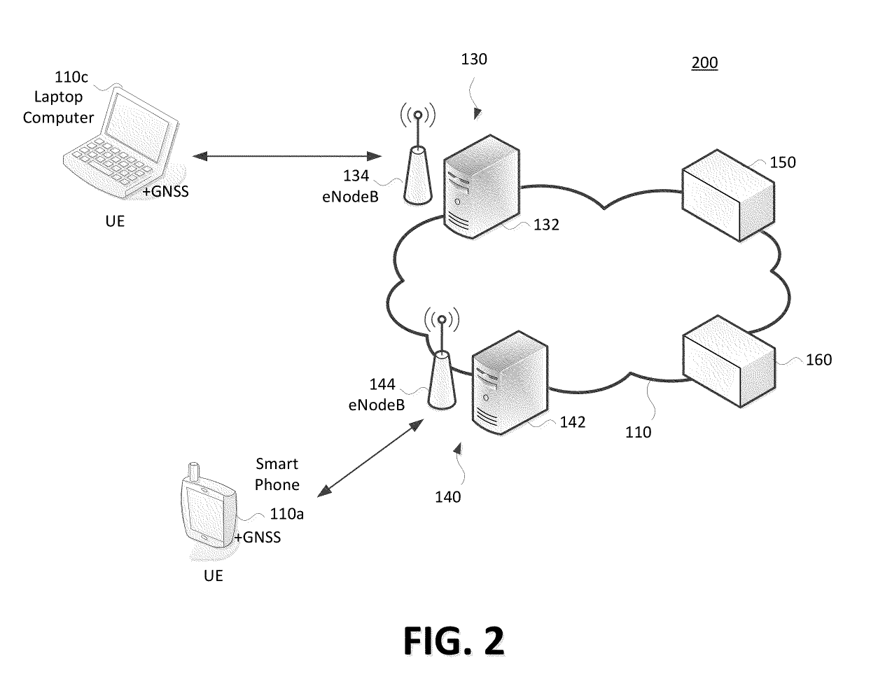

FIG. 2 is a block diagram illustrating an exemplary cellular communication network 200 included in the communication system of FIG. 1, in accordance with various aspects of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

In some aspects, the cellular communication network 200 represents the communication network 130 of FIG. 1. The cellular communication network 200 includes an Internet Protocol (IP) core network 210, base stations 230 and 240, GNSS-enabled mobile devices 110a and 110c, and gateways 250 and 260. Each of the base stations 230 and 240 may also be referred to as an evolved Node B (eNodeB), where Node B is in reference to a network node for a base transceiver station. Each of the mobile devices 110a and 110c may also be referred to as a user equipment (UE).

The IP core network 210 may include a multi-access core network that enables scalability and deployment flexibility. The gateways 250 and 260 may be operable for communication between the IP core network 210 and one or more other networks such as intranets, the Internet, IP Multimedia Subsystem (IMS), and the Public Switched Telephone Network (PSTN).

The base station 230 includes a transceiver 234 and an associated base station controller 232. In some aspects, when a reference is made to an eNodeB, it may be a reference to the transceiver of the base station or to both the transceiver of the base station and an associated base station controller. The transceiver 234 may include multiple antennas as well as suitable hardware and/or software for transmitting and receiving radio frequency (RF) signals and for communicating with the base station controller 232. The base station controller 232 may be operable to control or manage at least a portion of the communication between the base station 230 and the mobile device 110c. The base station controller 232 may be operable to provide transmission control operations for controlling or managing the amount of power that the GNSS-enabled mobile device 110c is to use for RF transmissions to the base station 230.

The base station 240 includes a transceiver 244 and an associated base station controller 242. The transceiver 244 and the base station controller 242 may operate in a substantially similar manner as the transceiver 234 and the base station controller 232 described above. In this regard, the base station controller 242 may be operable to provide transmission control operations for controlling or managing the amount of power that the GNSS-enabled mobile device 110a is to use for RF transmissions to the base station 240. While each base station is shown to have its own associated base station controller, some implementations of the subject technology may have more than one transceiver being associated to the same base station controller.

The GNSS-enabled mobile devices 110a and 110c may each include multiple transmit antennas and multiple receive antennas that may be operable to support Multiple-Input Multiple-Output (MIMO) communication with a base station. In some aspects, one or both of the GNSS-enabled mobile devices 110a and 110c is operable to communicate with a base station using Orthogonal Frequency Division Multiplexing (OFDM). Each of the GNSS-enabled mobile devices 110a and 110c may be operable to perform various transmission control operations for controlling or managing the amount of power that is to be used for RF transmissions to a base station.

Each of the GNSS-enabled mobile devices 110a and 110c may be configured to camp on the base stations 230 and 240 to access available services. In this regard, each of the base stations 230 and 240 may be operable to transmit a primary synchronization signal (PSS) and a secondary synchronization signal (SSS). The base station 240 may be operable to transmit the PSS and the SSS in the last two OFDM symbols of the first and eleventh slots in each RF transmission frame. The PSS is a sequence carrying the information of the identity of the base station or cell within a cell group. The SSS is a sequence carrying the information about the cell group, encoded with a scrambling sequence, which is unique to an associated GNSS-enabled mobile device. The scrambling code may be linked or mapped to, for example, the index of the PSS. After successful time and frequency synchronization via the PSS synchronization, the frame boundary synchronization and/or the cell identification may be performed via SSS detection. The transmission of the PSS and the SSS may allow timing and frequency offset issues to be resolved before cell-specific information may be determined.

To communicate with the base station 240, the GNSS-enabled mobile device 110a may be operable to determine one or more transmission parameters used by base station 240. Such information may be obtained by decoding a Broadcast Channel (BCH) signal from the base station 240. To that end, the GNSS-enabled mobile device 110a may need to synchronize to corresponding symbol timing and frame timing of transmissions from the base station 240 so as to acquire cell-specific parameters such as associated cell ID and/or antenna configuration. In operation, a GNSS-enabled mobile device or user equipment, such as the GNSS-enabled mobile device 110a, may transmit one or more preambles during a random access operation for detection by the base station 240.

LTE network discovery can be a time consuming process if the LTE UE (e.g., GNSS-enabled mobile device 100a) is required to do a blind search which involves searching all the carrier frequencies in the supported bands for LTE Cells, and then evaluating the found LTE Cells for PLMN suitability criteria. Optimizing this and reducing the blind LTE Cell search time is essential for user experience, e.g. if a user travels and powers on LTE phone in a new geographical location, a long delay may be if the blind search for LTE cell is not optimized. As such, the subject technology utilizes the geo-location information available from an in-device GNSS module to improve LTE network acquisition, for example.

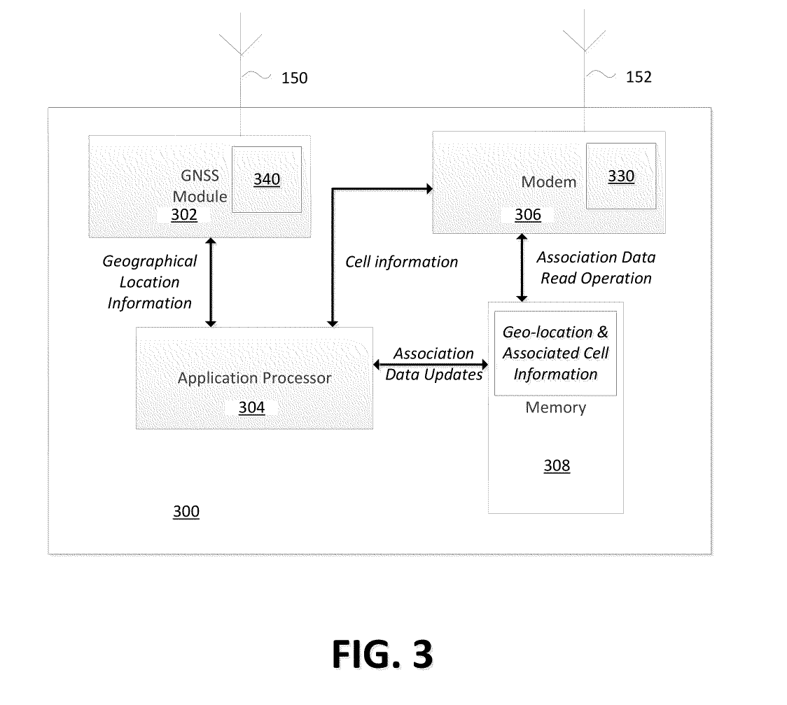

FIG. 3 is a block diagram illustrating an example of a GNSS enabled receiver 300 in accordance with various aspects of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The GNSS enabled receiver 300 includes a GNSS module 302, an application processor 304, a modem 306, and a memory 308. The GNSS module 302 includes an RF module 340 and an antenna 350. The modem 306 includes a baseband processor 330 and an antenna 352.

In some aspects, the application processor 304 is communicatively coupled to the GNSS module 302 and the modem 306. In turn, the memory 308 is coupled to the modem 306 and the application processor 304. In certain aspects, the application processor 304 is not involved (or implemented) in the GNSS enabled receiver 300, and therefore, the GNSS module 302 and modem 306 may communicate directly to each other and share information necessary to achieve the cellular network discovery.

The GNSS module 302 may be configured to determine geographical location information (e.g., geo-location coordinates) of the GNSS enabled receiver 300 (e.g., calculating navigation information such as GNSS receiver positions, velocity, and time). The RF module 340 may be operable to provide down-conversion of received RF signals to baseband signals that are communicated to the baseband processor 330 for further processing.

As shown in FIG. 3, the application processor 304 is coupled to the GNSS module 302 and modem 306. The application processor 304 may be operable to control, configure, and/or manage the memory 308, the baseband processor 330, and the RF module 340. The application processor 304 may be configured to store association data in the memory 308. The association data may include the geographical location information from the GNSS module 302 and associated cell information from the modem 306.

In some aspects, the modem 306 is communicatively coupled to the GNSS module 302 (e.g., via application processor 304) and configured to perform a cell search based on previously camped cell information associated with the geographical location information. The modem 306 may be configured to retrieve one of the previously camped cell information entries from the memory 308 based on corresponding geographical location information (e.g., association data read operation).

Camped cell information can be associated with the geographical location information provided by the GNSS module 302 and preserved in the memory 308. While initiating a cell search, if the GNSS module 302 is enabled, current geo-location coordinates can be used to lookup associated previously camped cell information. The GNSS enabled receiver 300 may be configured to initiate the cell search and camping process on a cell associated with the current geo-location coordinates to avoid invoking a blind cell search.

The application processor 304 may be configured to receive new geographical location information of the mobile device from the GNSS module 302. In turn, the application processor 304 may compare the new geographical location information with stored geographical location information and store the new geographical location information (e.g., association data update) in the memory 308 if the new geographical location information is different from the stored geographical location information. In certain aspects, the application processor 304 updates stored cell information with new cell information associated with the new geographical location information if the new cell information is different from the stored cell information.

In some aspects, the application processor 304 is configured to receive new cell information of an associated cell from the modem 306. In turn, the application processor 304 may compare the new cell information with stored cell information and store the new cell information (e.g., association data update) in the memory 308 if the new cell information is different from the stored cell information. In some aspects, the application processor 304 updates stored geographical location information with new geographical location information associated with the new cell information if the new geographical location information is different from the stored geographical location information.

The baseband processor 330 may be operable to process baseband information for cellular communication (e.g., LTE, 2G, 3G). The baseband information may include data, networking information, protocol information, and/or other like information, and may be received through signals provided by the RF module 340, the application processor 304, and/or the memory 308. The baseband processor 330 may be operable to support MIMO and/or OFDM operations for wireless communication with a base station.

The baseband processor 330 may be operable to perform operations associated with transmission power control. In this regard, the baseband processor 330 may be operable to calculate a power headroom value to be communicated to a base station, to determine appropriate corrections to be made to an accumulated value related to the transmission power to be used by the mobile terminal or user equipment 300, and/or determine an appropriate power with which to initialize data transmission via PUSCH and PUCCH.

The memory 308 may be operable to store information associated with the operation of the GNSS enabled receiver 300. The memory 308 may be configured to store the geographical location information and associated cell information. In certain aspects, the memory 308 is configured to store multiple previously camped cell information entries associated with respective geographical location information. In some aspects, the memory 308 is non-volatile memory.

In certain aspects, the antennas 350 and 352 are receiver (Rx) only antennas. The antennas 350 and 352 may be operable to support MIMO communication and/or any other type of smart antenna technology in which two or more receive antennas are utilized.

In one or more implementations, a mobile device having a GNSS module and a modem covers a device having one or more processors performing one or more functions of a GNSS module and a modem. In one or more implementations, a mobile device having a GNSS module, a modem and an application processor covers a device having one or more processors performing one or more functions of a GNSS module, a modem and an application processor.

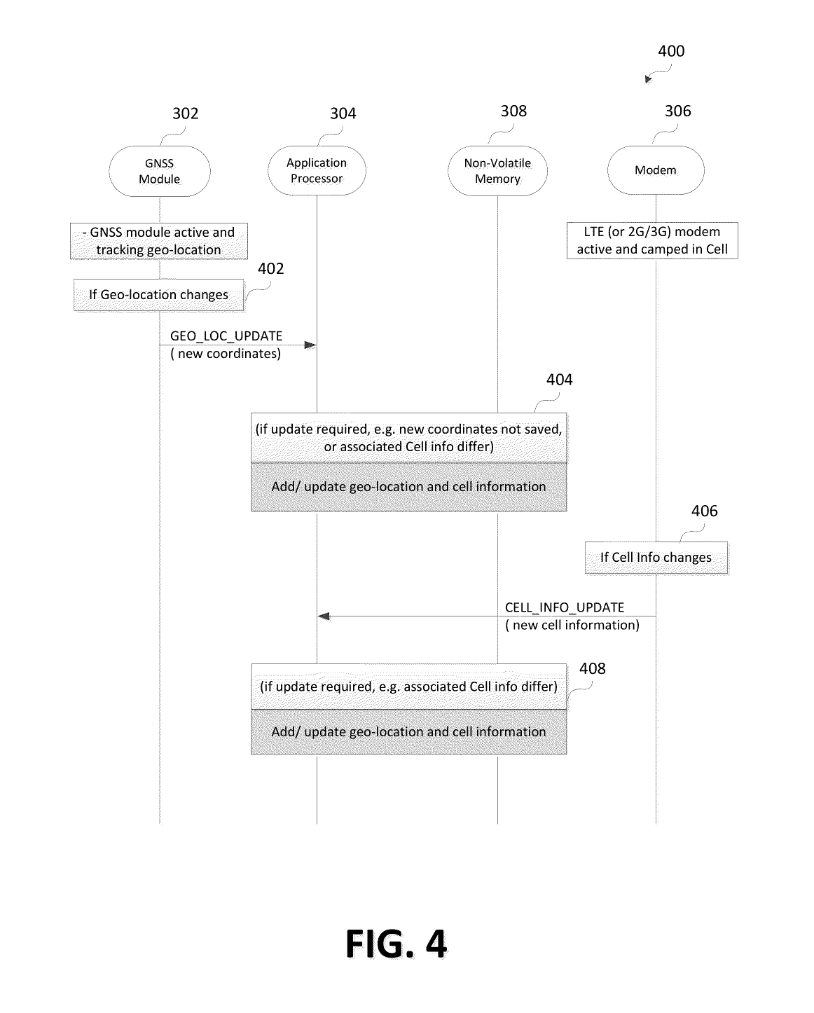

FIG. 4 is a diagram illustrating an example of a communication exchange 400 of geo-location information and associated cell information, in accordance with various aspects of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

In order to facilitate the utilization of geographical location information in cellular network discovery, the GNSS module 302 is active and tracking geographical location information (e.g., geographical location coordinates of GNSS enabled receiver 300). Also, the modem 306 is active and camped on a cell or base station.

In the event the geo-location coordinates of the GNSS enabled receiver 300 changes, the application processor 304 is configured to detect a geographical location update. In some aspects, the application processor 304 has dedicated datapaths to the GNSS module 302 (sometimes referred to as hooks) that communicate the geographical location information gathered and processed by the GNSS module 302. In some aspects, the application processor 304 monitors the hooks on a periodic basis. In this regard, the application processor 304 may lookup entries stored in the memory 308 periodically to determine any changes.

In some aspects, the application processor 304 is configured to update the memory 308 if an update is determined to be necessary. In this regard, the application processor 304 may update the memory 308 if the geographical location information has changed, the geographical location information has not been previously recorded, or the cell information associated with the geographical location information has changed.

In some aspects, the communication exchange 400 includes an update process 402, where the application processor 304 is configured to receive a first geographical location coordinate of a mobile device (e.g., GNSS enabled receiver 300). In turn, the application processor 304 may determine if the first geographical location coordinate is different from a second geographical location coordinate representing a current location of the mobile device. Based on the comparison, the application processor 304 is configured to assign the first geographical location coordinate as the current location of the device if the first geographical location coordinate is determined to be different from the second geographical location coordinate.

In certain aspects, the communication exchange 400 includes an update process 404, where the application processor 304 is configured to receive a new geographical location coordinate of the mobile device. In turn, the application processor 304 is configured to determine if the new geographical location coordinate is stored in the memory 308. After checking the memory 308, the application processor 304 may be configured to store the new geographical location coordinate if the new geographical location coordinate is determined not to be stored in the memory 308. In some aspects, the new geographical location coordinate is associated with corresponding cell information.

The update process 404 also may include the application processor 304 configured to facilitate receipt of new geographical location information of the mobile device from the GNSS module 302. In turn, the application processor 304 may compare the new geographical location information with geographical location information stored in the memory 308. The application processor 304 may store the new geographical location information if the new geographical location information is different from the stored geographical location information. In certain aspects, the application processor 304 updates stored cell information with new cell information associated with the new geographical location information if the new cell information is different from the stored cell information.

In certain aspects, the communication exchange 400 includes an update process 406, where the application processor 304 configured to receive new cell information based on a geographical location of the mobile device. The application processor 304 may determine if the new cell information is different from previously camped cell information associated with the geographical location of the mobile device. In turn, the application processor 304 stores the new cell information if the new cell information is determined to be different from the previously camped cell information. In certain aspects, the new cell information is associated with the geographical location of the mobile device.

In certain aspects, the communication exchange 400 includes an update process 408, where the application processor 304 is configured to facilitate receipt of new cell information of an associated cell. In turn, the application processor 304 compares the new cell information with stored cell information. The application processor 304 may store the new cell information if the new cell information is different from the stored cell information. In some aspects, the application processor 304 updates stored geographical location information with new geographical location information associated with the new cell information if the new geographical location information is different from the stored geographical location information.

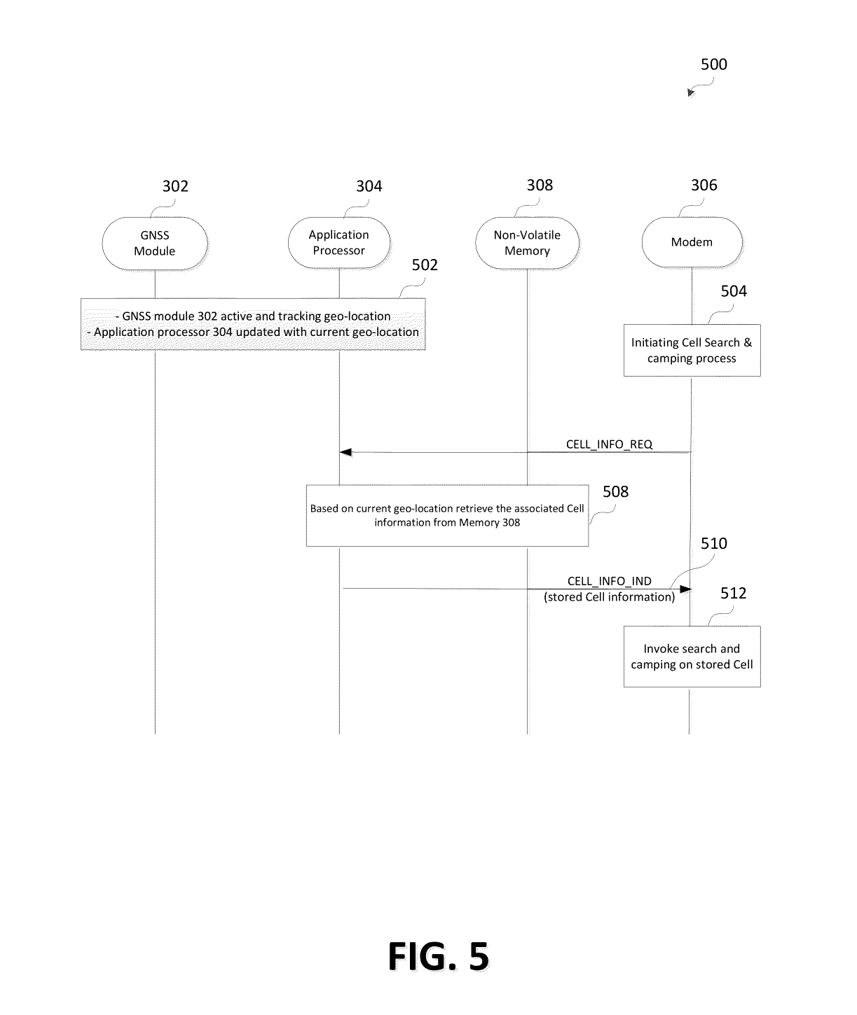

FIG. 5 is a diagram illustrating an example of a communication exchange 500 for geo-location assisted cellular network discovery, in accordance with various aspects of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

In order to facilitate the utilization of geographical location information in cellular network discovery, the GNSS module 302 is active and tracking geographical location information (e.g., geographical location coordinates of GNSS enabled receiver 300). Also, the application processor 304 is updated with current geographical location information of the mobile device (e.g., GNSS enabled receiver 300). In this regard, the application processor 304 is configured to receive geographical location coordinates from the GNSS module 302 at process 502. The application processor 304 may monitor the GNSS module 302 for any updates in the current geo-location of the mobile device.

At process 504, the modem 306 initiates a cell search and camping process. At process 506, the application processor 304 may be configured to facilitate receipt of a request from the modem 306 to initiate a cell search and camping process.

In response to the request, the application processor 304 may look up associated cell information in the memory 308 based on current geographical location information of the mobile device at process 508. Since the mobile device is GNSS enabled, the application processor 304 facilitates receipt of geographical location information of the mobile device. In this regard, the application processor 304 may retrieve stored cell information based on the current geographical location information. In some aspects, the modem 306 is configured to retrieve the stored cell information.

In certain aspects, the geographical location information includes one or more geographical location coordinates of the mobile device. In this regard, the process 508 may include a sub-process for determining if the stored cell information includes previously camped cell information of a cell that is located within a specified radius from a geographical location coordinate of the mobile device included in the current geographical location information. As such, the memory search may be narrowed to retrieve stored cell information that is within 500 meters from the mobile device versus 2 kilometers in broader searches, for example. The stored cell information may be retrieved by the application processor 304 if the previously camped cell information is determined by the application processor 304 to be within the specified radius.

In some aspects, there may be multiple available cells located at a common geographical location. In this regard, the cell information of each of the multiple cells may be stored in the memory 308 in accordance with the associated geographical location information. The application processor 304 may be configured to perform a sub-search among the available cells to determine the suitable cell to camp on. In certain aspects, some or all of the available cells at the common geographical location may be suitable to camp on at one point in time but may not be suitable at a different point in time (e.g., signal strength variation over time).

The process 508 also may include a sub-process for searching through several associated data entries stored in the memory 308, where each of the associated data entries includes geographical location information and associated cell information. The application processor 304 may compare the current geographical location information against each of the associated data entries to determine a match. In turn, the application processor 304 may select at least one of the associated data entries if a match is determined. In searching through the associated data entries, the application processor 304 may be configured to hash the geographical location information to index the associated cell information for a more expedient cell search.

At process 510, the application processor 304 provides the associated cell information stored in the memory 308 to the modem 306. At process 512, the modem 306 may invoke the search (e.g., invoking a cell search based on the stored cell information associated with the current geographical location information) and camp on a cell on a cellular network specified by previously camped cell information included in the stored cell information.

The process 512 may include a sub-process for discovering a plurality of cells having respective signal strengths, where at least one of the cells is associated with the stored cell information. The application processor 304 (or modem 306) may be configured to determine if any of the cells associated with the stored cell information satisfies a specified public land mobile network (PLMN) criterion. The application processor 304 may be configured to select at least one of the cells associated with stored cell information if the cell associated with the stored cell information is determined to satisfy the specified PLMN criterion. Cells not associated with the stored cell information may have signal strengths that are greater than signal strengths of the selected cell. In this regard, the application processor 304 may be configured to select the cell associated with the stored cell information over any of the cells having greater signal strength.

The application processor 304 may be configured to invoke a cell search of one or more carrier frequencies to search for one or more cells if the stored cell information is unavailable in the memory 308. In some aspects, the search through the frequency band is needed to initiate the geo-location assisted cellular network discovery. In turn, the application processor 304 facilitates camp on one of the one or more cells and facilitates receipt of camped cell information of the one of the one or more cells. The application processor 304 may associate the camped cell information with a current geographical location of the mobile device to generate associated information. In certain aspects, the application processor 304 stores the associated information in the memory 308, where the memory 308 is configured to store associated information corresponding to multiple geographical locations of the mobile device.

In some aspects, the application processor 304 is configured to associate the associated information stored in the memory 308 with camped cell information of multiple cells corresponding to a same geographical location as the associated information. In this regard, the application processor 304 may need to perform a sub-search of the multiple cells to determine the more suitable cell using conventional cell selection (or cell reselection) approaches. The advantage here is that the sub-search would require much less time than conventional cell searches without the utilization of the geo-location information.

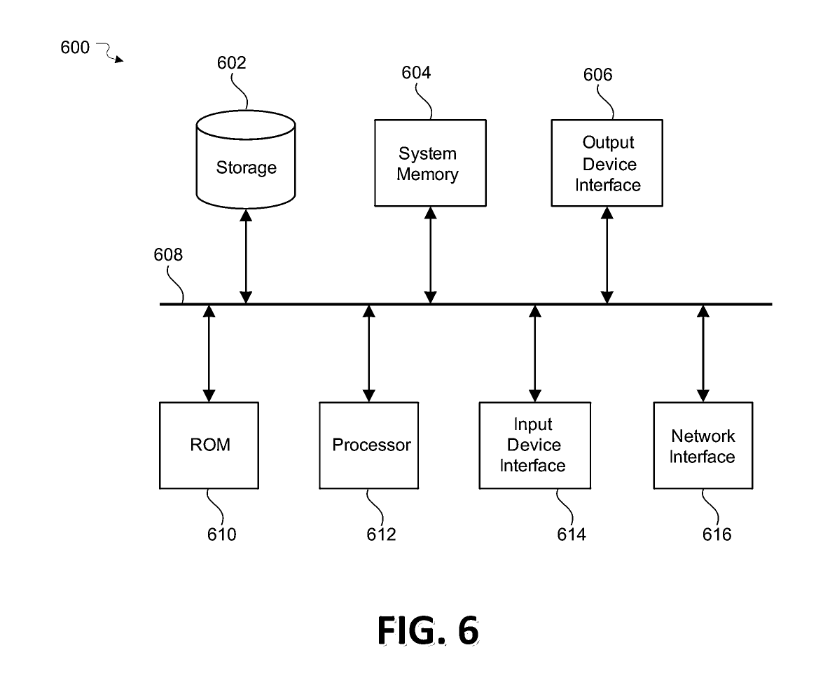

FIG. 6 conceptually illustrates an electronic system 600 with which one or more implementations of the subject technology may be implemented. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The electronic system 600, for example, can be a laptop computer, a tablet computer, a receiver, a phone, a personal digital assistant (PDA), or generally any electronic device that transmits wireless signals over a network. The electronic system 600 can be, and/or can be a part of GNSS enabled receiver 300 (FIG. 3) or GNSS-enabled mobile devices 110a-110c. Such an electronic system 600 includes various types of computer readable media and interfaces for various other types of computer readable media. The electronic system 600 includes a bus 608, one or more processing unit(s) 612, a system memory 604, a read-only memory (ROM) 610, a permanent storage device 602, an input device interface 614, an output device interface 606, a local area network (LAN) interface 616, and a wide area network (WAN) interface 618, or subsets and variations thereof.

The bus 608 collectively represents all system, peripheral, and chipset buses that communicatively connect the numerous internal devices of the electronic system 600. In one or more implementations, the bus 608 communicatively connects the one or more processing unit(s) 612 with the ROM 610, the system memory 604, and the permanent storage device 602. From these various memory units, the one or more processing unit(s) 612 retrieves instructions to execute and data to process in order to execute the processes of the subject disclosure. The one or more processing unit(s) 612 can be a single processor or a multi-core processor in different implementations.

The ROM 610 stores static data and instructions that are needed by the one or more processing unit(s) 612 and other modules of the electronic system 600. The permanent storage device 602, on the other hand, may be a read-and-write memory device. The permanent storage device 602 may be a non-volatile memory unit that stores instructions and data even when the electronic system 600 is off. In one or more implementations, a mass-storage device (such as a magnetic or optical disk and its corresponding disk drive) may be used as the permanent storage device 602.

In one or more implementations, a removable storage device (such as a flash drive or a universal serial bus (USB) drive) may be used as the permanent storage device 602. Like the permanent storage device 602, the system memory 604 may be a read-and-write memory device. However, unlike the permanent storage device 602, the system memory 604 may be a volatile read-and-write memory, such as random access memory. The system memory 604 may store any of the instructions and data that one or more processing unit(s) 612 may need at runtime. In one or more implementations, the processes of the subject disclosure are stored in the system memory 604, the permanent storage device 602, and/or the ROM 610. From these various memory units, the one or more processing unit(s) 612 retrieves instructions to execute and data to process in order to execute the processes of one or more implementations.

In some aspects, the electronic system 600 includes a computer program product with instructions stored in a tangible computer-readable storage medium such as permanent storage device 602. The instructions may include instructions for facilitating receipt of geographical location information of a mobile device, instructions for retrieving stored cell information based on the geographical location information, and instructions for invoking a cell search based on the stored cell information associated with the geographical location information.

The bus 608 also connects to the input and output device interfaces 614 and 606. The input device interface 614 enables a user to communicate information and select commands to the electronic system 600. Input devices that may be used with the input device interface 614 may include, for example, alphanumeric keyboards and pointing devices (also called “cursor control devices”). The output device interface 606 may enable, for example, the display of images generated by electronic system 600. Output devices that may be used with the output device interface 606 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, the bus 608 also couples the electronic system 600 to a network (not shown) through the LAN interface 616 and separately, or jointly, through the WAN interface 618. In this manner, the electronic system 600 can be a part of a network of computers, such as a LAN through the LAN interface 616, a WAN through the WAN interface 618, an Intranet through either of the interfaces 616, 618, or a network of networks through either of the interfaces 616, 618, such as the Internet. Any or all components of the electronic system 600 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method of cellular network discovery on a mobile device, comprising:
facilitating receipt of geographical location information of the mobile device;
retrieving stored cell information based on the geographical location information; and
invoking a cell search based on the stored cell information associated with the geographical location information.

2. The method of claim 1, further comprising:
invoking a cell search of one or more carrier frequencies to search for one or more cells when the stored cell information is unavailable;
facilitating camp on one of the one or more cells;
facilitating receipt of camped cell information of the one of the one or more cells;
associating the camped cell information with a current geographical location of the mobile device to generate associated information; and
storing the associated information in a memory, wherein the memory includes associated information corresponding to a plurality of geographical locations of the mobile device.

3. The method of claim 2, further comprising associating the associated information stored in the memory with camped cell information of a plurality of cells corresponding to a same geographical location as the associated information.

4. The method of claim 1, wherein the geographical location information comprises one or more geographical location coordinates of the mobile device, and wherein retrieving the stored cell information comprises searching for previously camped cell information associated with geographical location information that is within a specified range of geographical location coordinates.

5. The method of claim 1, wherein invoking the cell search comprises:
discovering a plurality of cells having respective signal strengths, wherein at least one of the plurality of cells is associated with the stored cell information;
determining if the at least one of the plurality of cells associated with the stored cell information satisfies a specified public land mobile network (PLMN) criteria; and
selecting the at least one of the plurality of cells associated with the stored cell information when the at least one of the plurality of cells associated with the stored cell information is determined to satisfy the specified PLMN criteria, wherein cells of the plurality of cells not associated with the stored cell information have signal strengths that are greater than signal strengths of the selected cell.

6. The method of claim 1, wherein retrieving the stored cell information comprises:
searching through a plurality of associated data entries stored in a memory, wherein each of the plurality of associated data entries comprises geographical location information and associated cell information;
comparing the geographical location information against each of the plurality of associated data entries to determine a match; and
selecting at least one of the plurality of associated data entries when a match is determined.

7. The method of claim 6, wherein searching through the plurality of associated data entries comprises hashing the geographical location information to index the associated cell information.

8. The method of claim 1, wherein retrieving the stored cell information comprises determining if the stored cell information includes previously camped cell information of a cell that is located within a specified radius from a geographical location coordinate of the mobile device, and wherein the stored cell information is retrieved when the previously camped cell information is determined to be within the specified radius.

9. The method of claim 1, wherein invoking the cell search comprises camping on a cell on a cellular network specified by previously camped cell information included in the stored cell information.

10. The method of claim 1, further comprising:
receiving a first geographical location coordinate of the mobile device;
determining if the first geographical location coordinate is different from a second geographical location coordinate representing a current location of the mobile device; and
assigning the first geographical location coordinate as the current location of the device when the first geographical location coordinate is determined to be different from the second geographical location coordinate.

11. The method of claim 1, further comprising:
receiving a new geographical location coordinate of the mobile device;
determining if the new geographical location coordinate is stored in a memory; and
storing the new geographical location coordinate when the new geographical location coordinate is determined not to be stored in the memory, wherein the new geographical location coordinate is associated with corresponding cell information.

12. The method of claim 1, further comprising:
receiving new cell information based on a geographical location of the mobile device;
determining if the new cell information is different from previously camped cell information associated with the geographical location of the mobile device; and
storing the new cell information when the new cell information is determined to be different from the previously camped cell information, wherein the new cell information is associated with the geographical location of the mobile device.

13. The method of claim 1, further comprising:
facilitating receipt of a request to initiate a cell search and camping process;
looking up associated cell information in a memory based on current geographical location information of the mobile device; and
providing the associated cell information stored in the memory in response to the request.

14. The method of claim 1, further comprising:
facilitating receipt of new geographical location information of the mobile device;
comparing the new geographical location information with stored geographical location information;
storing the new geographical location information when the new geographical location information is different from the stored geographical location information; and
updating stored cell information with new cell information associated with the new geographical location information when the new cell information is different from the stored cell information.

15. The method of claim 1, further comprising:
facilitating receipt of new cell information of an associated cell;
comparing the new cell information with stored cell information;
storing the new cell information when the new cell information is different from the stored cell information; and
updating stored geographical location information with new geographical location information associated with the new cell information when the new geographical location information is different from the stored geographical location information.

16. A mobile device, comprising:
a global navigation satellite system (GNSS) module configured to determine geographical location information of the mobile device;
a memory configured to store the geographical location information and associated cell information, wherein the memory is configured to store a plurality of previously camped cell information entries associated with respective geographical location information; and
a modem communicatively coupled to the GNSS module and configured to perform a cell search based on previously camped cell information associated with the geographical location information, wherein the modem is configured to retrieve one of the plurality of previously camped cell information entries from the memory based on corresponding geographical location information.

17. The mobile device of claim 16, further comprising:
an application processor coupled to the GNSS module and modem, the application processor configured to store association data in the memory, wherein the association data comprises the geographical location information and the associated cell information.

18. The mobile device of claim 17, wherein the application processor is configured to:
receive new geographical location information of the mobile device from the GNSS module;
compare the new geographical location information with stored geographical location information;
store the new geographical location information in the memory when the new geographical location information is different from the stored geographical location information; and
update stored cell information with new cell information associated with the new geographical location information when the new cell information is different from the stored cell information.

19. The mobile device of claim 17, wherein the application processor is configured to:
receive new cell information of an associated cell from the modem;
compare the new cell information with stored cell information;
store the new cell information in the memory when the new cell information is different from the stored cell information; and
update stored geographical location information with new geographical location information associated with the new cell information when the new geographical location information is different from the stored geographical location information.

20. A computer program product comprising instructions stored in a tangible computer-readable storage medium, the instructions comprising:
instructions for facilitating receipt of geographical location information of a mobile device;
instructions for retrieving stored cell information based on the geographical location information; and
instructions for invoking a cell search based on the stored cell information associated with the geographical location information.
